(19) United States
(12) Patent Application Publication
(10) Pub. No.: US 2019/0213249 A1
(43) Pub. Date: Jul. 11, 2019

(54) Intelligent Copy and Paste

(71) Applicant: International Business Machines Corporation, Armonk, NY (US)

(72) Inventors: Michael D. Kistler, Austin, TX (US); Kevin Lai, Austin, TX (US); Gelaren Taban, Austin, TX (US)

(21) Appl. No.: 15/863,380

(22) Filed: Jan. 5, 2018

(51) Int. Cl. G06F 17/27; G06F 17/30; G06F 17/24

(52) U.S. Cl. CPC G06F 17/278; G06F 17/24; G06F 17/2785; G06F 17/30684

(57) ABSTRACT

A mechanism is provided in a data processing system comprising a processor and a memory wherein the memory comprises instructions which are executed by the processor to cause the processor to be specifically configured to implement a user interface and a cognitive text analysis engine for intelligent copy-and-paste. In response to a user performing a copy-and-paste operation via the user interface to copy a text snippet from a source context and paste the text snippet into a target context, the cognitive text analysis engine analyzes the source context, the text snippet, and the target context to identify key elements. The cognitive text analysis engine identifies elements that are present in the source context and the text snippet but not present in the target context. The user interface highlights the identified elements within text snippet pasted into the target context. In response to receiving user input via the user interface modifying a given highlighted element in the text snippet pasted into the target context, the mechanism edits the given highlighted element in the target context.

### BACKGROUND

The present application relates generally to an improved data processing apparatus and method and more specifically to mechanisms for intelligent copy and paste.

In human-computer interaction, cut, copy and paste are related commands that offer a user-interface inter-process communication technique for transferring data. The cut command removes the selected data from its original position, while the copy command creates a duplicate; in both cases the selected data is kept in a temporary storage tool called the clipboard. The data in the clipboard is later inserted in the position where the paste command is issued. The data is available to any application supporting the feature, thus allowing easy data transfer between applications. The command names are an interface metaphor based on the physical procedure used in manuscript editing to create a page layout. This interaction technique has close associations with related techniques in graphical user interfaces that use pointing devices such as a computer mouse (by drag and drop, for example). The capability to replicate information with ease, changing it between contexts and applications, involves privacy concerns because of the risks of disclosure when handling sensitive information.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system comprising a processor and a memory wherein the memory comprises instructions which are executed by the processor to cause the processor to be specifically configured to implement a user interface and a cognitive text analysis engine for intelligent copy-and-paste. The method comprises, in response to a user performing a copy-and-paste operation via the user interface to copy a text snippet from a source context and paste the text snippet into a target context, analyzing, by the cognitive text analysis engine, the source context, the text snippet, and the target context to identify key elements. The method further comprises identifying, by the cognitive text analysis engine, elements that are present in the source context and the text snippet but not present in the target context. The method further comprises highlighting, via the user interface, the identified elements within text snippet pasted into the target context. The method further comprises, in response to receiving user input via the user interface modifying a given highlighted element in the text snippet pasted into the target context, editing the given highlighted element in the target context.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 is a block diagram of a mechanism for intelligent copy-and-paste in accordance with an illustrative embodiment;

FIG. 4 illustrates identification of candidate elements in copied text in accordance with an illustrative embodiment;

FIGS. 5A-5D depict an example of an intelligent copy-and-paste operation in accordance with an illustrative embodiment; and

FIG. 6 is a flowchart illustrating operation of a mechanism for intelligent copy-and-paste in accordance with an illustrative embodiment.

### DETAILED DESCRIPTION

Text that is copied from one context and pasted into another context often must be revised to fit the new context. In all current systems, the user must identify the revisions to be made using the user's knowledge of the source and destination contexts.

The illustrative embodiments provide a mechanism for intelligent copy-and-paste that uses a cognitive text analysis engine to identify key elements of the source context, the text snippet being copied, and the target context and to highlight elements in the text snippet that may be modified when pasted into the target context. Text analysis identifies the entities (nouns) and intents (verbs) in the source and target contexts. Entities or intents present in both the source context and the text snippet but not in the target context are highlighted as candidates for modification. If the user chooses to modify one instance of an entity or intent in the copied text, the mechanism may offer to change all instances of the entity or intent in the pasted text snippet.

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

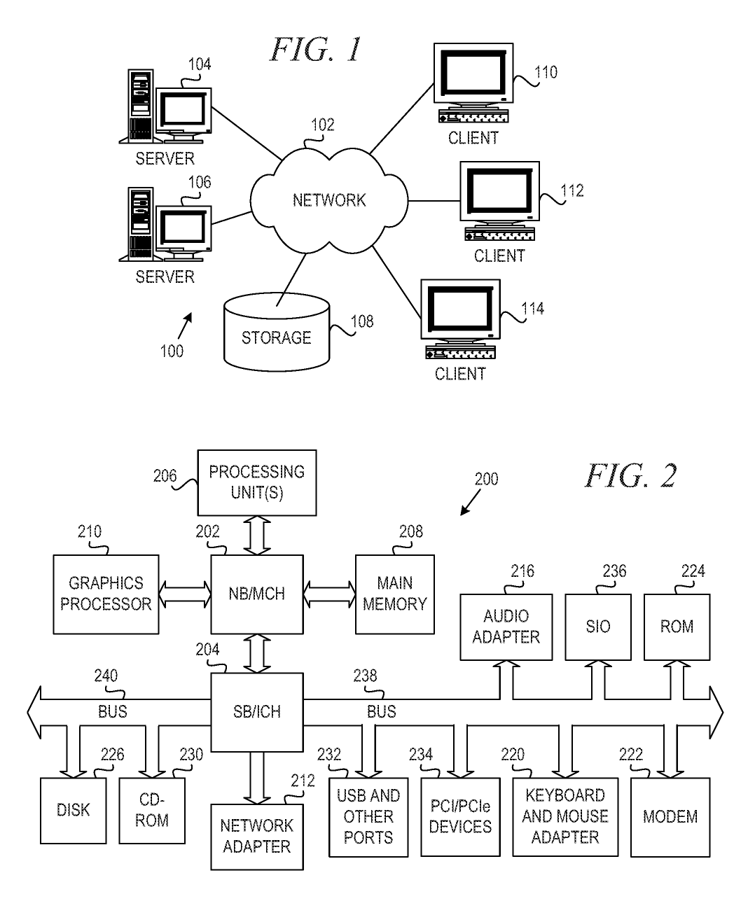

The illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

As shown in FIG. 1, one or more of the computing devices, e.g., client 110, may be specifically configured to implement a mechanism for intelligent copy-and-paste. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates the intelligent copy-and-paste.

As noted above, the mechanisms of the illustrative embodiments utilize specifically configured computing devices, or data processing systems, to perform the operations for the intelligent copy and paste. These computing devices, or data processing systems, may comprise various hardware elements which are specifically configured, either through hardware configuration, software configuration, or a combination of hardware and software configuration, to implement one or more of the systems/subsystems described herein. FIG. 2 is a block diagram of just one example data processing system in which aspects of the illustrative embodiments may be implemented. Data processing system 200 is an example of a computer, such as server 104 in FIG. 1, in which computer usable code or instructions implementing the processes and aspects of the illustrative embodiments of the present invention may be located and/or executed so as to achieve the operation, output, and external effects of the illustrative embodiments as described herein.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM eServer™ System P® computer system, Power™ processor based computer system, or the like, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

As mentioned above, in some illustrative embodiments the mechanisms of the illustrative embodiments may be implemented as application specific hardware, firmware, or the like, application software stored in a storage device, such as HDD 226 and loaded into memory, such as main memory 208, for executed by one or more hardware processors, such as processing unit 206, or the like. As such, the computing device shown in FIG. 2 becomes specifically configured to implement the mechanisms of the illustrative embodiments and specifically configured to perform the operations and generate the outputs described hereafter with regard to the mechanism for intelligent copy-and-paste.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

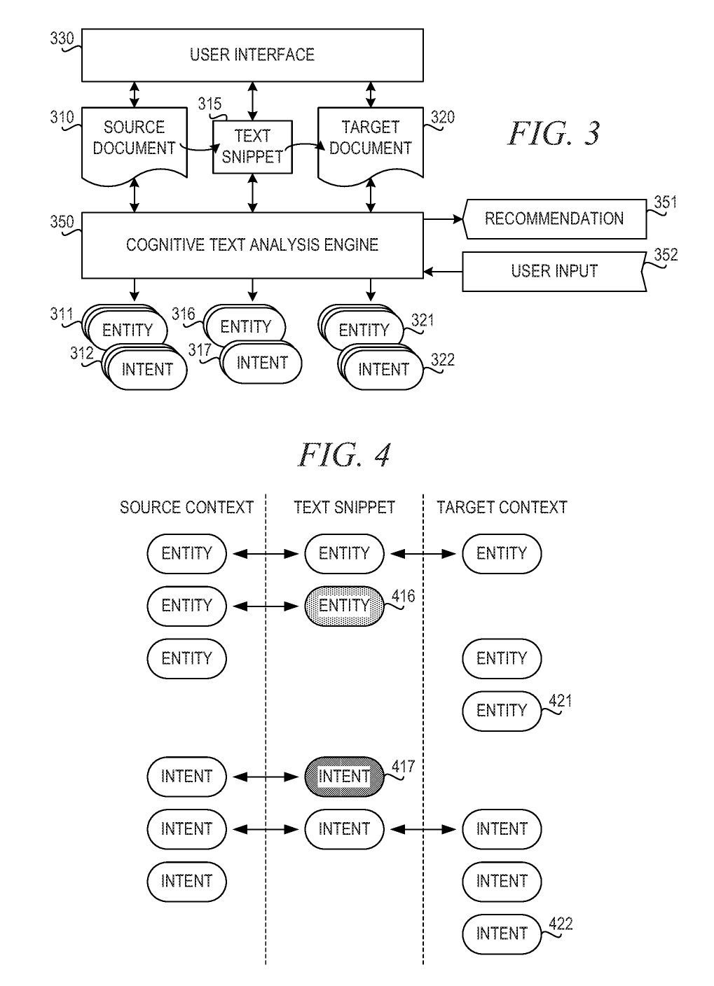

FIG. 3 is a block diagram of a mechanism for intelligent copy-and-paste in accordance with an illustrative embodiment. User interface 330 receives user inputs and commands from a user in the form of keystrokes, mouse movements, mouse clicks, and the like. In accordance with the illustrative embodiment, the user performs a copy-and-paste operation via user interface 330 to copy a text snippet 315 from source document 310 and paste the text snippet 315 into target document 320. The copy-and-paste operation involves copying the text snippet 315 from source document 310 in computer memory into a “clipboard” portion of the computer memory and subsequently inserting the text snippet 315 from the clipboard into target document 320 in computer memory.

Cognitive text analysis engine 350 performs natural language processing (NLP) to identify key elements of the source context, text snippet, and target context. Cognitive text analysis engine 350 may be an online or cloud service, such as the IBM Watson® Conversation tool. Cognitive text analysis engine 350 may perform part-of-speech tagging, parsing, sentence boundary disambiguation, word segmentation, lexical semantics, named entity recognition, and the like. In one embodiment, cognitive text analysis engine may perform speech recognition or optical character recognition. In accordance with the illustrative embodiments, the key elements are natural language elements, such as key parts of speech or semantic elements of predetermined semantic types. In one embodiment, the key elements may include entities (nouns) and intents (verbs), although the key elements may include other elements. Cognitive text analysis engine 350 identifies entities 311 and intents 312 in source document 310, entities 316 and intents 317 in text snippet 315, and entities 321 and intents 322 in target document 320.

Cognitive text analysis engine 350 may identify entities and intents in the source context and target context, which may include all of or a portion of the source document and target document, respectively. For example, the source context may be the text immediately surrounding the text snippet 315 in source document 310, and the target context may be the surrounding text into which the text snippet 315 is being pasted. The boundary of the source context or target context may be determined by a predetermined threshold of words, lines, or pages. Alternatively, the boundary of the source context or target context may be delineated by explicit document boundaries, such as paragraphs, pages, chapters, or the like. Furthermore, in one embodiment, source context and target context may be different portions of the same document.

Cognitive text analysis engine 350 highlights elements in text snippet 315 that are candidates for modification when pasted into the target context. Cognitive text analysis engine 350 identifies entities or intents present in both the source context and the text snippet but not in the target context as potentially requiring modification. In one example embodiment, cognitive text analysis engine 350 also identifies an entity or intent in the target context that may be a candidate replacement element. Cognitive text analysis engine 350 outputs the highlighted elements and optionally the candidate replacement elements as one or more recommendations 351. Cognitive text analysis engine 350 also receives user input 352 to determine whether the user wishes to modify the highlighted elements in the pasted text snippet 315 within the target document as recommended. User interface 330 may then perform the modification or replacement of the highlighted elements.

Furthermore, cognitive text analysis engine 350 may identify a candidate element to be modified that appears multiple times in the text snippet 315. If the user wishes to modify one instance of such an entity or intent in the pasted text, cognitive text analysis engine 350 may offer to change all instances of that entity in the pasted text snippet. User interface 330 may then perform the replacement of the remaining instances of the identified candidate elements.

FIG. 4 illustrates identification of candidate elements in copied text in accordance with an illustrative embodiment. The source context includes a plurality of entities and a plurality of intents. The text snippet copied from the source context includes a plurality of entities and a plurality of intents. The target context includes a plurality of entities and a plurality of intents. The cognitive text analysis engine identifies an entity 416 and an intent 417 that are present in the source context but not present in the target context. The cognitive text analysis engine may also identify an entity 421 and an intent 422 that are not present in the source context or the text snippet. The cognitive text analysis engine may highlight entity 416 and intent 417 as candidate elements to be modified. The cognitive text analysis engine may also recommend entity 421 and intent 422 as candidate elements for replacing the highlighted elements.

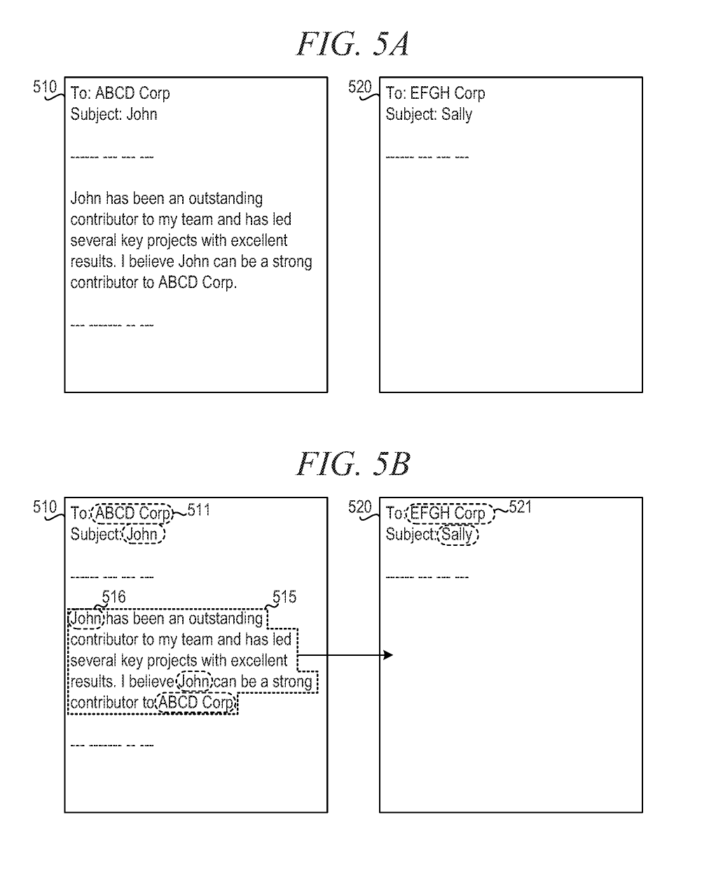

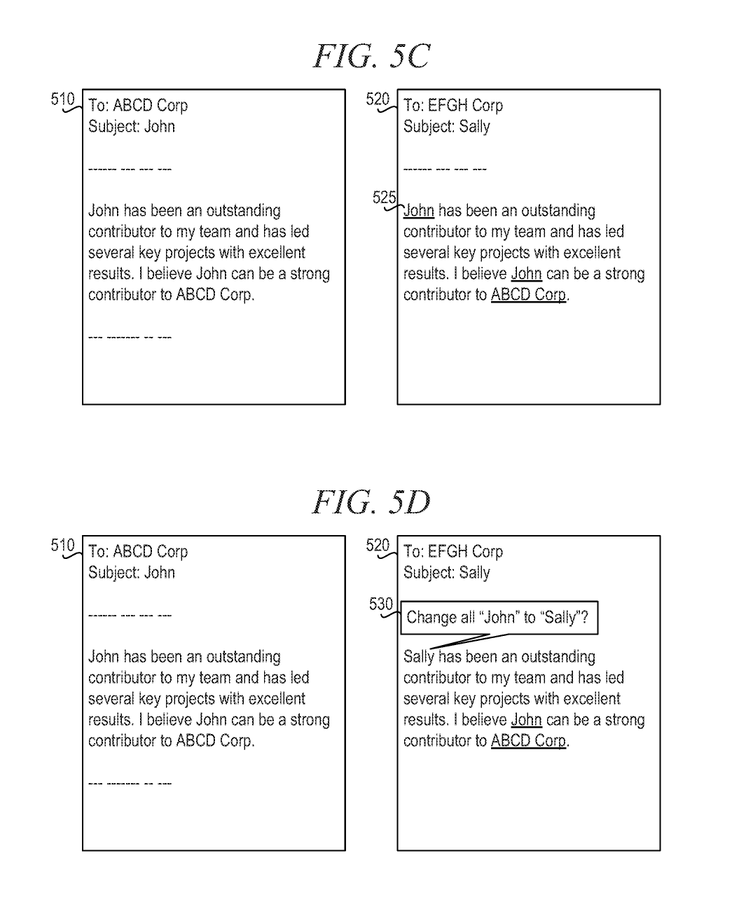

FIGS. 5A-5D depict an example of an intelligent copy-and-paste operation in accordance with an illustrative embodiment. With reference to FIG. 5A, the source document 510 may be a recommendation the user wrote for John to a position with ABCD Corp. The user needs to write a recommendation for Sally for a similar position with EFGH Corp. John and Sally are both strong contributors, and the user wants to reuse some of the text from John's recommendation in the recommendation for Sally in the target document 520.

Turning to FIG. 5B, the user selects a text snippet 515 to be copied from John's recommendation in the source document 510. The mechanism for intelligent copy-and-paste identifies elements (e.g., entities “ABCD Corp,” “John”) 511, 516 in the source context within the source document 510 and identifies elements (e.g., entities “John,” “ABCD Corp”) 516 within the text snippet 515. In accordance with one embodiment, the source context may include text surrounding the text snippet 515 excluding the text snippet itself. The source context may include the entire source document 510 other than the text snippet 515 or may include a portion of the surrounding text based on a predetermined number of words, sentences, paragraphs, etc. or based on explicit document boundaries. The cognitive text analysis engine also identifies elements (e.g., entities “EFGH Corp,” “Sally”) 521 within the target context within the target document 520.

With reference now to FIG. 5C, the text snippet is pasted into the target document 520. The cognitive text analysis engine identifies and highlights elements 525 that are in the text snippet and the source context but not in the target context. In this example, the entities are the instances of “John” and “ABCD Corp.” The user may then select the highlighted elements for modification or replacement.

In one example embodiment, the cognitive text analysis engine may provide recommended replacement elements to replace the selected highlighted element. The recommended replacement elements may be elements that appear in the target context but not in the text snippet. For example, the entities “EFGH Corp” and “Sally” appear in the target document 520 but do not appear in the pasted text snippet.

The mechanism for intelligent copy-and-paste may identify multiple instances of the same entity, such as entity “John” 525 in FIG. 5C. Turning to FIG. 5D, the mechanism may present a dialog 530 through the user interface prompting the user to change all instances to the same modified or replacement element. In the example shown in FIG. 5D, in response to the user replacing “John” with “Sally,” the mechanism asks the user to change all instances of “John” with “Sally.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

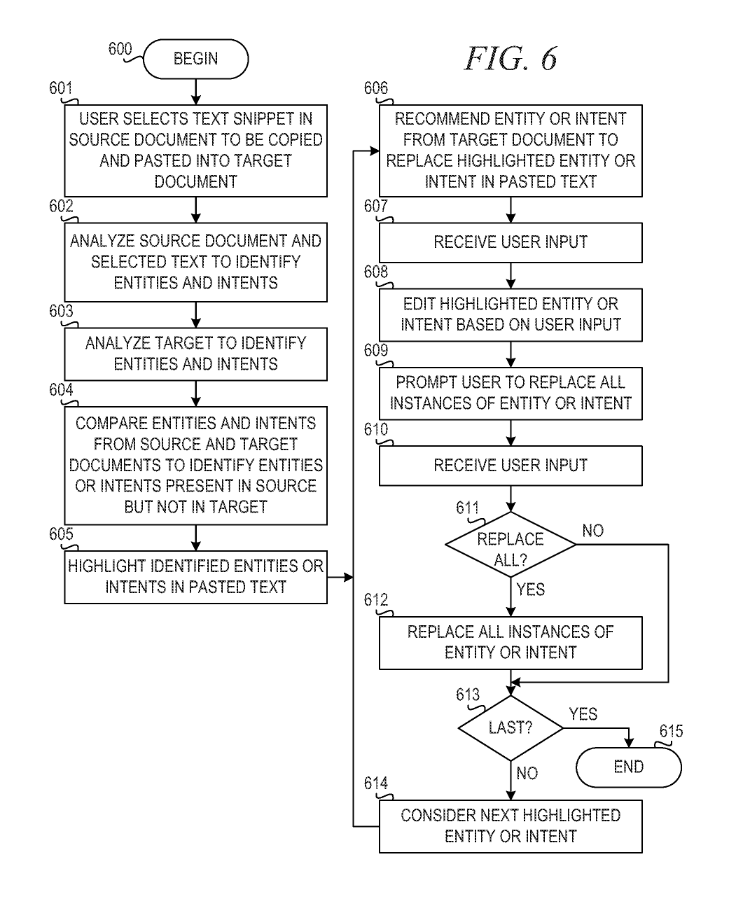

FIG. 6 is a flowchart illustrating operation of a mechanism for intelligent copy-and-paste in accordance with an illustrative embodiment. Operation begins (block 600), and the user selects a text snippet in a source document to be copied and pasted into a target document (block 601). The mechanism analyzes the source context of the source document and the selected text to identify entities and intents (block 602). The mechanism analyzes the target context in the target document to identify entities and intents (block 603). The mechanism compares entities and intents from the source and target documents to identify entities or intents present in the source context but not in the target context (block 604).

The mechanism highlights the identified entities or intents in the pasted text snippet (block 605). Then, the mechanism recommends an entity or intent from the target document to replace the highlighted entity or intent in the pasted text (block 606). The mechanism receives user input (block 607) and edits the highlighted entity or intent based on the user input (block 608).

If there are multiple instances of the highlighted entity or intent, then the mechanism prompts the user to replace all instances of the highlighted entity or intent (block 609). The mechanism receives user input (block 610) and determines whether the user input indicates that the user wishes to replace all instances of the highlighted entity or intent (block 611). If the user wishes to replace all instances, then the mechanism replaces all instances of the entity or intent (block 612).

Thereafter, or if the user does not wish to replace all instances in block 612, the mechanism determines whether the current entity or intent is the last entity or intent identified and highlighted entity or intent in the pasted text (block 613). If the current entity or intent is not the last highlighted entity or intent in the pasted text, then the mechanism considers the next highlighted entity or intent (block 614), and operation returns to block 606. If the current entity or intent is the last highlighted entity or intent in the pasted text in block 613, then operation ends (block 615).

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, the illustrative embodiments provide a mechanism for intelligent copy-and-paste. The mechanism greatly reduces the potential for copy-and-paste errors, which are a very common form of mistake in normal correspondence, software development, and other realms that rely on text documents to communicate information. The illustrative embodiments may apply to word processing, electronic mail and chat applications, software source code editing, or any other environment in which snippets of text may be copied and pasted into different contexts.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

1. A method, in a data processing system comprising a processor and a memory wherein the memory comprises instructions which are executed by the processor to cause the processor to be specifically configured to implement a user interface and a cognitive text analysis engine for intelligent copy-and-paste, the method comprising:
in response to a user performing a copy-and-paste operation via the user interface to copy a text snippet from a source context and paste the text snippet into a target context, analyzing, by the cognitive text analysis engine, the source context, the text snippet, and the target context to identify key elements;
identifying, by the cognitive text analysis engine, candidate elements that are present in the source context and the text snippet but not present in the target context;
highlighting, via the user interface, the identified candidate elements within text snippet pasted into the target context;
identifying, by the cognitive text analysis engine, at least one replacement element present in the target context but not present in the source context;
recommending, by the cognitive text analysis engine, the at least one replacement element present in the target context but not present in the source context as a replacement for the given highlighted element; and
in response to receiving user input via the user interface selecting to replace a given candidate element with a given replacement element, editing the given highlighted element in the target context to replace a given candidate element with the selected replacement element.

2. The method of claim 1, wherein the key elements comprise entities or intents.

3. (canceled)

4. The method of claim 1, further comprising:
responsive to the cognitive text analysis engine determining that the given highlighted element appears in the text snippet multiple times, prompting, by the cognitive text analysis engine via the user interface, the user whether to replace all instances of the given highlighted element; and
responsive to receiving user input indicating to replace all instances of the given highlighted element, replacing all instances of the given highlighted element in the text snippet pasted into the target context.

5. The method of claim 1, wherein the source context is a source document and the target context is a target document.

6. The method of claim 1, wherein the source context is a portion of a source document and the target context is a portion of a target document.

7. The method of claim 6, wherein the portion of the source document comprises a predetermined number of words surrounding the text snippet in the source document.

8. The method of claim 6, wherein the portion of the target document comprises a predetermined number of words surrounding a location within the target document at which the text snippet is pasted.

9. The method of claim 6, wherein the portion of the source document and the portion of the target document are delineated by explicit document boundaries.

10. The method of claim 1, wherein the source context is a first portion of a source document and the target context is a second portion of the source document.

11. A computer program product comprising a non-transitory computer readable storage medium having a computer readable program stored therein, wherein the computer readable program, when executed on a processor of a data processing system, causes the data processing system to implement a user interface and a cognitive text analysis engine for intelligent copy-and-paste, wherein the computer readable program causes the data processing system to:
in response to a user performing a copy-and-paste operation via the user interface to copy a text snippet from a source context and paste the text snippet into a target context, analyze, by the cognitive text analysis engine, the source context, the text snippet, and the target context to identify key elements;
identify, by the cognitive text analysis engine, candidate elements that are present in the source context and the text snippet but not present in the target context;
highlight, by the user interface via the user interface, the identified candidate elements within text snippet pasted into the target context;
identify, by the cognitive text analysis engine, at least one replacement element present in the target context but not present in the source context;
recommend, by the cognitive text analysis engine, the at least one replacement element present in the target context but not present in the source context as a replacement for the given highlighted element; and
in response to receiving user input via the user interface selecting to replace a given candidate element with a given replacement element, edit the given highlighted element in the target context to replace a given candidate element with the selected replacement element.

12. The computer program product of claim 11, wherein the key elements comprise entities or intents.

13. (canceled)

14. The computer program product of claim 11, wherein the computer readable program further causes the data processing system to:
responsive to the cognitive text analysis engine determining that the given highlighted element appears in the text snippet multiple times, prompt, by the cognitive text analysis engine via the user interface, the user whether to replace all instances of the given highlighted element; and
responsive to receiving user input indicating to replace all instances of the given highlighted element, replace all instances of the given highlighted element in the text snippet pasted into the target context.

15. The computer program product of claim 11, wherein the source context is a source document and the target context is a target document.

16. The computer program product of claim 11, wherein the source context is a portion of a source document and the target context is a portion of a target document.

17. The computer program product of claim 16, wherein the portion of the source document comprises a predetermined number of words surrounding the text snippet in the source document.

18. The computer program product of claim 16, wherein the portion of the target document comprises a predetermined number of words surrounding a location within the target document at which the text snippet is pasted.

19. The computer program product of claim 16, wherein the portion of the source document and the portion of the target document are delineated by explicit document boundaries.

20. An apparatus comprising:
a processor; and
a memory coupled to the processor, wherein the memory comprises instructions which, when executed by the processor, cause the processor to implement a user interface and a cognitive text analysis engine for intelligent copy-and-paste, wherein the instructions cause the processor to:
in response to a user performing a copy-and-paste operation via the user interface to copy a text snippet from a source context and paste the text snippet into a target context, analyze, by the cognitive text analysis engine, the source context, the text snippet, and the target context to identify key elements;
identify, by the cognitive text analysis engine, candidate elements that are present in the source context and the text snippet but not present in the target context;
highlight, via the user interface, the identified candidate elements within text snippet pasted into the target context;
identify, by the cognitive text analysis engine, at least one replacement element present in the target context but not present in the source context;
recommend, by the cognitive text analysis engine, the at least one replacement element present in the target context but not present in the some context as a replacement for the given highlighted element; and
in response to receiving user input via the user interface selecting to replace a given candidate element with a given replacement element, edit the given highlighted element in the target context to replace the given candidate element with the selected replacement element.

21. The apparatus of claim 20, wherein the key elements comprise entities or intents.

22. The apparatus of claim 20, wherein the instructions cause the processor to:
responsive to the cognitive text analysis engine determining that the given highlighted element appears in the text snippet multiple times, prompting, by the cognitive text analysis engine via the user interface, the user whether to replace all instances of the given highlighted element; and
responsive to receiving user input indicating to replace all instances of the given highlighted element, replacing all instances of the given highlighted element in the text snippet pasted into the target context.
